(19) United States
(12) Patent Application Publication
(10) Pub. No.: US 2025/0291916 A1
(43) Pub. Date: Sep. 18, 2025

(54) Identification of a Compromised Artificial Intelligence (AI) Algorithm

(71) Applicant: MICRO FOCUS LLC, WILMINGTON, DE (US)

(72) Inventors: DOUGLAS MAX GROVER, RIGBY, ID (US); MICHAEL F. ANGELO, HOUSTON, TX (US); Manish Marwah, Pleasanton, CA (US)

(73) Assignee: MICRO FOCUS LLC, WILMINGTON, DE (US)

(21) Appl. No.: 18/603,035

(22) Filed: Mar. 12, 2024

(51) Int. Cl. G06F 21/56

(52) U.S. Cl. CPC G06F 21/563; G06F 2221/033

(57) ABSTRACT

Baseline structure information and/or baseline weight information associated with an AI algorithm is retrieved. For example, the baseline weight information may comprise a hash a weight of the AI algorithm. Current structure information and/or current weight information associated with the AI algorithm is retrieved. The baseline structure information and/or the baseline weight information is compared to the current structure information and/or the current weight information. In response to the baseline structure information and/or the baseline weight information being different from the current structure information and/or the current weight information, a determination is made that the AI algorithm has been compromised. In response to the baseline structure information and/or the baseline weight information being the same as the current structure information and/or the current weight information, a determination is made that the AI algorithm has not been compromised.

### FIELD

The disclosure relates generally to Artificial Intelligence (AI) Algorithms and particularly to identification of a compromised AI algorithm.

### BACKGROUND

One of the problems with AI algorithms is that they can be hacked in various ways. While doing a simple hash of an AI algorithm may identify that the AI algorithm source code/binary has changed, simply detecting that the hash of an AI algorithm is different from what it was previously cannot determine specifically how the AI algorithm is being attacked. For example, the AI algorithm may have been changed to produce a new bias in the AI algorithm, which cannot be determined using a single hash of the AI algorithm.

### SUMMARY

These and other needs are addressed by the various embodiments and configurations of the present disclosure. The present disclosure can provide a number of advantages depending on the particular configuration. These and other advantages will be apparent from the disclosure contained herein.

Baseline structure information and/or baseline weight information associated with an AI algorithm is retrieved. For example, the baseline structure information may comprise a hash of source code for a node in the AI algorithm and baseline weight information may comprise a hash of a weight of the AI algorithm. Current structure information and/or current weight information associated with the AI algorithm is retrieved. The baseline structure information and/or the baseline weight information is compared to the current structure information and/or the current weight information. In response to the baseline structure information and/or the baseline weight information being different from the current structure information and/or the current weight information, a determination is made that the AI algorithm has been compromised. In response to the baseline structure information and/or the baseline weight information being the same as the current structure information and/or the current weight information, a determination is made that the AI algorithm has not been compromised.

The phrases “at least one”, “one or more”, “or,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “blockchain” as described herein and in the claims refers to a growing list of records, called blocks, which are linked using cryptography. The blockchain is commonly a decentralized, distributed and public digital ledger that is used to record transactions across many computers so that the record cannot be altered retroactively without the alteration of all subsequent blocks and the consensus of the network. Each block contains a cryptographic hash of the previous block, a timestamp, and transaction data (generally represented as a merkle tree root hash). For use as a distributed ledger, a blockchain is typically managed by a peer-to-peer network collectively adhering to a protocol for inter-node communication and validating new blocks. Once recorded, the data in any given block cannot be altered retroactively without alteration of all subsequent blocks, which requires consensus of the network majority. In verifying or validating a block in the blockchain, a hashcash algorithm generally requires the following parameters: a service string, a nonce, and a counter. The service string can be encoded in the block header data structure, and include a version field, the hash of the previous block, the root hash of the merkle tree of all transactions (or information or data) in the block, the current time, and the difficulty level. The nonce can be stored in an extraNonce field, which is stored as the left most leaf node in the merkle tree. The counter parameter is often small at 32-bits so each time it wraps the extraNonce field must be incremented (or otherwise changed) to avoid repeating work. When validating or verifying a block, the hashcash algorithm repeatedly hashes the block header while incrementing the counter & extraNonce fields. Incrementing the extraNonce field entails recomputing the merkle tree, as the transaction or other information is the left most leaf node. The body of the block contains the transactions or other information. These are hashed only indirectly through the Merkle root.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for identifying a compromised AI algorithm.

FIG. 2 is a block diagram of an exemplary neural network of an AI algorithm.

FIG. 3 is a block diagram of exemplary weight file and an exemplary weight hash file.

FIG. 4 is a block diagram of an exemplary AI algorithm structure map and an exemplary node structure hash file.

FIG. 5 is a flow diagram of a process for identifying a compromised AI algorithm.

FIG. 6 is a flow diagram of a process for determining which baseline information to use when determining if an AI algorithm has been compromised.

FIG. 7 is an exemplary display of a baseline AI structure in comparison to a current AI structure.

FIG. 8 is an exemplary display of a baseline weight structure in comparison to a current weight structure.

FIG. 9 is an exemplary embodiment of a blockchain for storing baseline AI structure information and baseline weight information.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

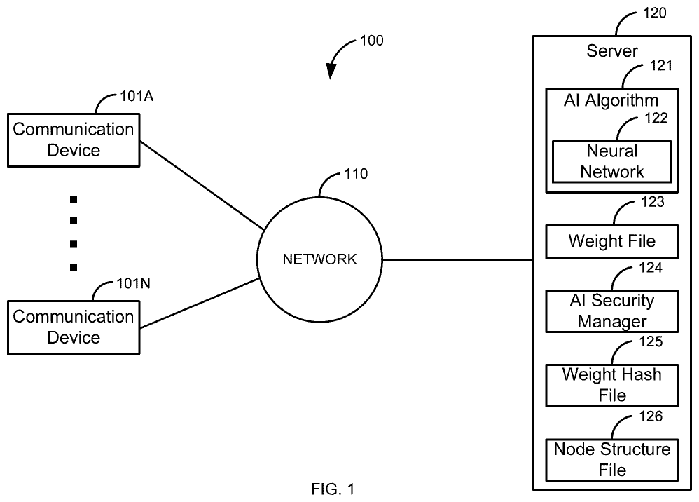

FIG. 1 is a block diagram of a first illustrative system 100 for identifying a compromised AI algorithm 121. The first illustrative system 100 comprises communication devices 101A-101N, a network 110, and a server 120.

The communication devices 101A-101N can be or may include any user device that can communicate on the network 110 in order to access the AI algorithm 121, such as a Personal Computer (PC), a cellular telephone, a Personal Digital Assistant (PDA), a tablet device, a notebook device, a smartphone, a laptop computer and/or the like. As shown in FIG. 1, any number of communication devices 101A-101N may be connected to the network 110, including only a single communication device 101.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 110 can use a variety of electronic protocols, such as Ethernet, Internet Protocol (IP), Hyper Text Transfer Protocol (HTTP), Web Real-Time Communications Protocol (Web RTC), and/or the like. Thus, the network 110 is an electronic communication network 110 configured to carry messages via packets and/or circuit switched communications.

The server 120 may be any type of device that can host the AI algorithm 121, such as an application server, a Software as a Service (SaaS), a cloud service, a private server, a public server, and/or the like. The server 120 further comprises the AI algorithm 121, a weight file 123, an AI security manager 124, a weight hash file 125, and a node structure file 126. The server 120 may comprise multiple servers 120 and/or processing cores that host the AI algorithm 121.

The AI algorithm 121 may be any type of AI algorithm 121 that uses a neural network 122. For example, the AI algorithm 121 may use a feed forward neural network, a generative adversarial neural network, a multilayer perceptron neural network, a convolutional neural network, a radial basis functional neural network, a long short-term memory neural network, a modular neural network, and/or the like. Examples of AI algorithms 121 may include ChatGPT®, GitHub Copilot®, ChatSonic®, Perplexity AI®, Amazon CodeWhisperer®, and/or the like.

The AI algorithm 121 comprises a neural network 122. The neural network 122 is a series of nodes/links that comprise a structure of the AI algorithm 121.

The weight file 123 is a file that contains the weights that are used to make the AI algorithm 121 work. The weights are generated when the AI algorithm 121 is trained using a training set (not shown). The weight file 123 is typically a sequential layer weight file 123 that is generated according to the layers in the neural network 122. The weight file 123 typically does not change unless the AI algorithm 121 is retrained/fine-tuned. The weight file 123 in this example, is a multi-dimensional matrix that is based on the layers of AI algorithm 121. When the AI algorithm 121 is loaded, each node in the AI algorithm 121 gets its associated weight from the weight file 123 using the multi-dimensional matrix to identify the correct weight. The weights are associated with the links (the pointers between the nodes).

The AI security manager 124 can be any hardware/software that can manage security of the AI algorithm 121. The AI security manager 124 can help to determine specific ways the AI algorithm 121 is being compromised. For example, the AI security manager 124 may determine that specific weights in the weight file 123 have changed.

The weight hash file 125 contains various kinds of hashes of the weights in the weight file 123. For example, the weight hash file 125 may comprise a hash of the weight file 123, individual hashes of all weights in the weight file 123, a hash of a layer of weights in the weight file 123, a hash of weights of a flow in the weight file 123, and/or the like. In addition, a combination and/or portions of these may be stored in the weight hash file 125.

The node structure file 126 contains various kinds of information about the structure of the AI algorithm 121, such as a hash of a node in the AI algorithm, a pointer to a next node in the AI algorithm, a length of the source code of the node of the AI algorithm, a location of the node in the AI algorithm, and/or the like.

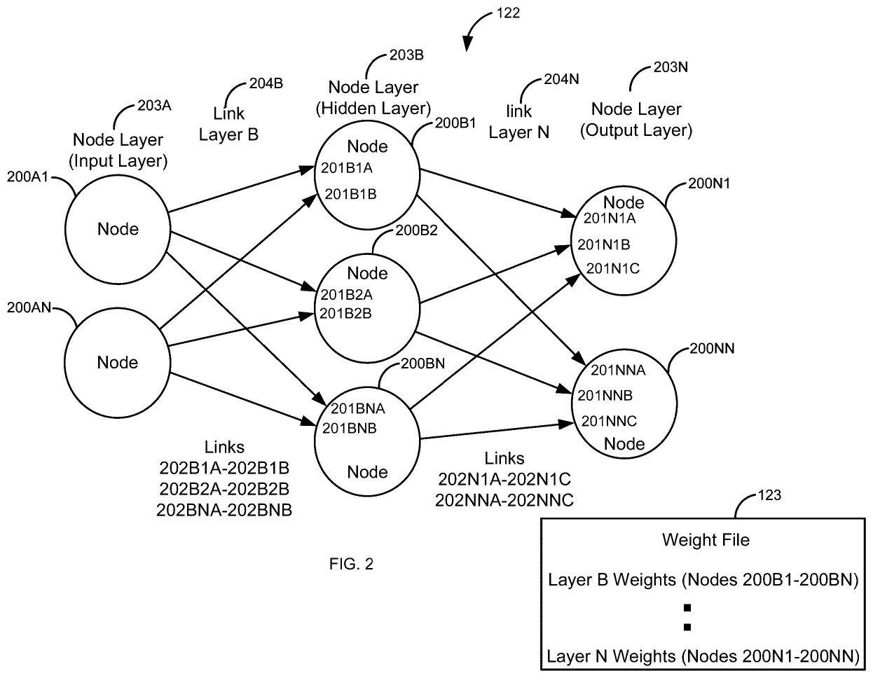

FIG. 2 shows a simple neural network 122 of an AI algorithm 121 for illustrative purposes. However, some AI algorithms 121 (e.g., a Large Language Model (LLM)) may comprises billions or even trillions of nodes 202/weights 201 and hundreds to even thousands of layers 203. Because of the extremely large numbers of nodes 202 and weights 201, running and checking an AI algorithm 121 that uses trillions of weights 201 and thousands of layers requires massive amounts of processing power, which cannot be done manually.

FIG. 2 is a block diagram of an exemplary neural network 122 (a fully connected neural network 122) of an AI algorithm 121. Although a fully connected neural network 122 is shown, the processes described herein will work for any type of neural network 122.

The neural network 122 comprises nodes 200A1-200AN, 200B1-200BN, and 200N1-200NN. The nodes 200A1-220AN comprise the node layer 203A (the input layer). The nodes 200B1-200BN comprise the node layer 203B (the hidden layer). The nodes 200N1-200NN comprise the node layer 203N (the output layer).

Between the node layers 203A and 203B is the link layer 204B. The link layer 204B comprises links 202B1A-202B1B, 202B2A-202B2B, and 202BNA-202BNB. For example, the link 202 between the node 200A1 and the node 200B 1 is identified as link 202B1A because it is related to the link layer 204B. Likewise, the link 202 between the node 200A1 and the node 200B2 is identified as link 202B2 and so on. Similarly, for the link 202 between the node 200B 1 and the node 200N1, the link 202 is identified as link 202N1A and so on.

The nodes 200B1-200BN and 200N1-200NN each have associated weights 201. This is because each of the nodes 200B1-200BN each have two input links 202. In this example, each of the nodes 200B1-200BN have two weights: 201B1A-201B1B for the node 200B1, 201B2A-201B2B for the node 200B2, and 201BNA-201BNB for the node 200BN. Similarly, the nodes 200N1-200NN have three associated weights. This is because there are three input links 202 to each of the nodes 200N1-200NN. In this example, the node 200N1 has associated weights 201N1A-201N1C and the node 200NN has associated weights 201NNA-201NNC.

When the AI algorithm 121 is loaded and executed, all the weights 201B1A-201B1B, 201B2A-201B2B, 201BNA-201BNB, 201N1A-201N1C, and 201NNA-201NNC are loaded from the weight file 123. All the weights 201B1A-201B1B, 201B2A-201B2B, 201BNA-201BNB, 201N1A-201N1C, and 201NNA-201NNC cause the AI algorithm 121 to work according to the training set. When the AI algorithm 121 is trained, the weight file 123 is generated.

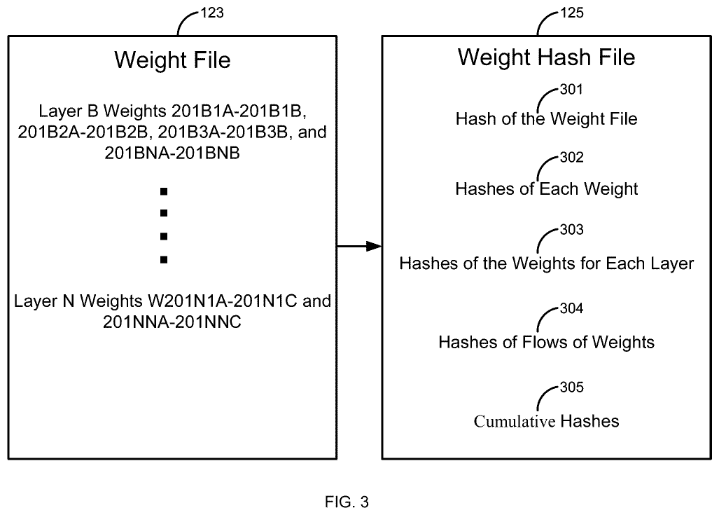

FIG. 3 is a block diagram of exemplary weight file 123 and an exemplary weight hash file 125. The weight file 123 comprises all the weights 201 as described in FIG. 2. The weight hash file 125 comprises a hash of the weight file 301, hashes of each of the weights in the weight file 302, hashes of the weights for each layer 303, hashes of the flows of weights 304, and cumulative hashes 305.

One way to compromise the AI algorithm 121 can be to change some or all of the weights 201 in the weight file 123. For example, the weights 201B1A and 201N1A may be changed by a nefarious party in the weight file 123. The changing of the weights 201 can cause a change in how the AI algorithm 121 works. To protect against this kind of attack, the weight hash file 125 is created using the weight file 123. The weight hash file 125 may be stored off separately from the weight file 123. For example, the weight hash file 125 may be stored on a separate server 120 or stored in a blockchain.

The weight hash file 125 may comprise one or more hashes that are used, not only to determine that the AI algorithm's weight file 123 has been compromised, but also to determine the specific weights 201 that have been compromised. The hash of the weight file 301 is a hash of the weight file 123. In one embodiment, the hash of the weight file 301 may include two different hashes of the weight file 123. For example, the first hash may be a Message Digest (MD) 5 hash and the second hash may be a Secure Hashing Algorithm (SHA) hash. The hashes may use the same key sizes or different key sizes. The use of two hashes is to prevent where a single hash is compromised based on a hash collision.

The hash of each weight 302 may be a single hash of each weight in the weight file 123 or a double hash as described above. While the number of weights may be in the billions or even trillions, with technologies such as quantum computing and high-performance processing, the ability to calculate billions or even trillions of hashes can be accomplished. In one embodiment, some, or all of the hashes may use a different key.

The hashes of the weights for each layer 303 is a hash of the weights for each layer 303 with the exception of the node layer 203A, which does not have any associated weights 201. For example, using FIG. 2, for the node layer 203B, the hash of the weights for the layer 303 would be a hash of weights 201B1A-201B1B, 201B2A-201B2B, and 201BNA-201BNB. Likewise, for node layer 203N, the hash of the weights for the layer 303 would be a hash of weights 201N1A-201N1C and 201NNA-201NNC. The hashes of weights for each layer 303 could also use two different hashes to protect against hash collisions.

The hashes of flows of weights 304 are hashes of flows between nodes 200 shown by the links 202 (the arrows between nodes 200). For example, a first flow would be a hash of the weights 201B1A and 201N1A. The second flow would be a hash of the weights 201B1A and 201NNA. The third flow would be a hash of the weights 201B1B and 201N1A. This would be repeated for each flow in the neural network 122 for a total of 12 flows in FIG. 2.

The cumulative hashes 305 of the node layers 203 may be computed, as a hash of weights for each of the layer 303. For example, the hashing process would start with a hash of the weights of the layer 203B, a hash of the weights for layer C (assuming that there is a layer C), and so on until the hash of the weights of output layer 203N. In this example, the cumulative hash would be a hash of the node layer 203B, then a hash of the node layer 203B+the node layer 203C (assuming there is one), and then a hash of all three layers. In many cases, this will result in a faster identification of the compromised layer/compromised weight.

By using one or more of: the hashes of each weight 302, the hashes of the weights for each layer 303, the hashes of flows of weights 304, and/or the cumulative hashes 305 a more detailed analysis of how the AI algorithm 121 is being attacked can be learned. For example, if a specific weight associated with a specific type of training data is changed, this can be used to notify a security analyst about the specific type of attack.

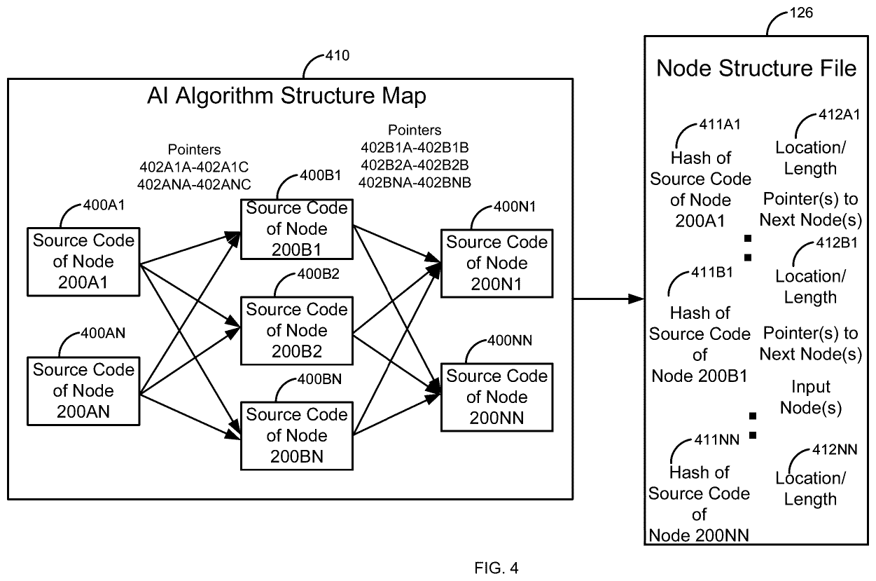

FIG. 4 is a block diagram of an exemplary AI algorithm structure map 410 and an exemplary node structure file 126. Another way to attack an AI algorithm 121 that uses a neural network 122 may be to compromise the source code of one or more nodes 200 in the neural network 122. This may be accomplished in various ways. For example, the source code for one or more nodes 200 may change, one or more nodes 200 may be removed, a new node 200 may be added into a flow, new node(s) 200 may be added to a layer 203, pointers 402 may be changed, pointers 402 between layers 203 may be changed, pointer(s) may be removed, and/or the like. For example, a new node 200BN+1 may be added to the node layer 203B that does not have an input but has a pointer 402 to the node 200NN. In this example the node 200NN would have a new weight (i.e., 201NNE) added as an input to the node 200NN.

FIG. 4 shows a layout of the source code (e.g., could be source code (i.e., Java) or a binary) of the AI algorithm 121/neural network 122 of FIG. 2. Typically, there may only be one instance of the source code of a node 400 that performs the particular function and all the nodes 200 that perform a similar function will have individual instances of the same source code of the node 400. If any changes are made to the source code of the node 400 (i.e., not while running), a change in the source code of the node 400 will affect all nodes 200 that use the same source code of the node 400. Alternatively, the attack could be made to a node 200 while the node 200 is running in real-time. In this example, only a single individual instance of a node 200 will be affected.

The AI security manager 124 learns the structure of the neural network 122. For example, the source code of the node 200A1 (400A1) has three pointers 402A1A-402A1C that point to the source code of the nodes 200B1-200BN (400B1-400BN). Likewise, the source code of the node 200AN (400AN) has three pointers 402ANA-402ANC that point to the source code of the nodes 200B1-200BN (400B1-400BN).

The pointers 402A1A-402A1C/402ANA-402ANC may be function calls to the source code of the nodes 200B1-200BN (400B1-400BN). For the source code of the nodes 200B1-200BN (400B1-400BN), each of the source code of the nodes 200B1-200BN (400B1-400BN) have two pointers 402B1A-402B1B, 402B2A-402B2B, and 402BNA-402BNB that point to the source code of the nodes 200N1-200NN (400N1-400NN).

All this information is stored in the node structure file 126. The node structure file 126 has a hash of the source code for each node 411, a location/length of the source code for each node and pointers 402 to the next node(s) 412 (unless the node 200 is an output node 200). The structure information along with hashes of the source code for each node 411 are stored in the node structure file 126. If the source code of the node 400 is used to create multiple nodes 200, there may only be a single hash of the source code of the nodes 411 even though there are multiple nodes 200 that use the same source code of the nodes 400. Thus, if the source code for a specific node 400 is changed, this can be detected because the hash will change. If a node 200 is removed or added, the structure of the neural network 122 changes and thus can be detected. If the pointers 402 change to another node 200 or another node 200 in another layer 203, this can also be detected. For example, if a new node 200 points to a node 200 at the next layer, the source code for the next layer node 200 will change because there is an additional input weight that is processed by the node 200 or an array size of the weight array will change.

The node structure file 126 is used to store the baseline structure information. The baseline structure information is used as a baseline when determining if the AI algorithm has been compromised. The node structure file 126 may be stored off separately on another server or stored in a blockchain.

Being not only able to identify specific weights that have been changed along with specific source code of nodes 400/pointers 402 that have changed can paint a detailed picture of how the AI algorithm 121 is being attacked. This may be used to not only determine where the AI algorithm 121 is being comprised, but also may be used to identify specifically how the AI algorithm 121 is being attacked. For example, if the source code of the nodes 400 being attacked are nodes 200 that deal with creation of vulnerabilities in source code, this can help a security analyst in determining how the AI algorithm 121 is being compromised.

If the AI algorithm 121 is retrained, the process will typically be repeated. Typically, when an AI algorithm 121 is retrained, the source code/structure of the AI algorithm 121 will not change. If the source code/structure of the of the AI algorithm 121 is not supposed to change, the current structure of the AI algorithm 121 can be checked against the source code/structure of the newly trained algorithm 121 to identify differences. If there is a difference, this can be flagged to indicate that the AI algorithm 121 has been compromised during retraining. The flag can indicate specific details of what has been compromised during retraining.

If the structure of the AI algorithm 121 does change when the AI algorithm 121 is retrained (i.e., is fine-tuned), and if the new structure is known, the expected structure can be compared to the structure of the newly trained AI algorithm 121. If the structure of the newly trained AI algorithm 121 is different this can also be flagged to indicate that the AI algorithm 121 has been compromised during retraining.

In addition, only a portion of the weights may be changed when the AI algorithm 121 is retrained or when the AI algorithm 121 is fine-tuned. In this case, the hashes will only need to be recomputed for the weights/layers/flows that have changed.

In addition, the structure of the weight file 123 (e.g., a multi-dimensional matrix) may be learned. If the structure of the weight file 123 has changed, this can also be identified. For example, if a new node 200 is added to the neural network 122, the structure of the weight file 123 would change to accommodate the added new node 200 and any weights 201 associated with the new node or weights associated with new link 202. This information can also be captured and used as part of the analysis for determining how the AI algorithm 121 has been compromised. For example, the structure of the compromised weight file 123 may be displayed in comparison to the structure of the non-compromised weight file 123.

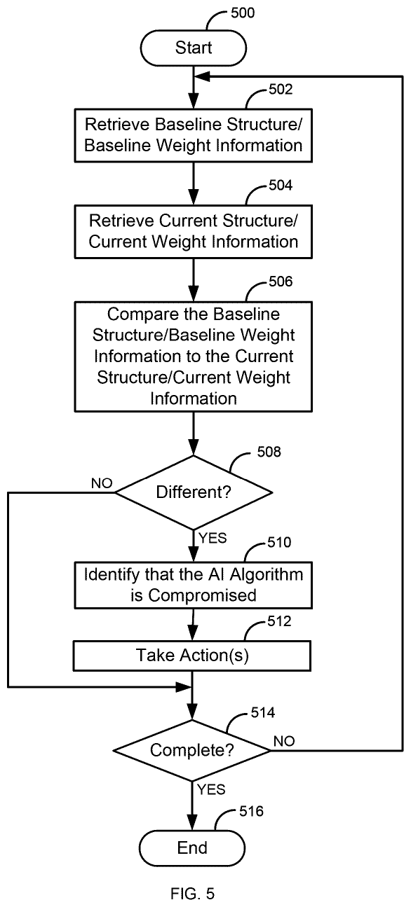

FIG. 5 is a flow diagram of a process for identifying a compromised AI algorithm 121. Illustratively, the communication devices 101A-101N, the server 120, the AI algorithm 121, the neural network 122, and the AI security manager 124, are stored-program-controlled entities, such as a computer or microprocessor, which performs the method of FIGS. 5-9 and the processes described herein by executing program instructions stored in a computer readable storage medium, such as a memory (i.e., a computer memory, a hard disk, and/or the like). Although the methods described in FIGS. 5-9 are shown in a specific order, one of skill in the art would recognize that the steps in FIGS. 5-9 may be implemented in different orders and/or be implemented in a multi-threaded environment. Moreover, various steps may be omitted or added based on implementation.

The process starts, in step 500. The AI security manager 124 retrieves, in step 502, the baseline structure information/baseline weight information. The baseline structure information may be the information that is stored in the node structure file 126 when the AI algorithm 121/neural network 122 is created. The baseline weight information may be the information that is stored in the weight hash file 125 when the AI algorithm 121 is trained.

The AI security manager 124, retrieves, in step 504, the current structure information/current weight information. The current structure information is the same parameters (e.g., hashes, pointers 402, etc.) of the baseline structure information, except it is the current structure information. Likewise, the current weight information is the same parameters (e.g., hashes, etc.) of the baseline weight information, except it is the current weight information.

The baseline structure information/baseline weight information is compared to the current structure information/current weight information in step 506. For example, the current structure information may be hashes of the source code of the nodes 400A1-400AN, 400B1-400BN, and 400N1-400NN that were computed when the AI algorithm 121 was initially loaded or when the AI algorithm 121 is running in real-time (captured from memory). The comparison may be between the baseline hashes of the weights for each of the layers 303 in relation to the current hashes of the weights for each of the layers 303 and/or the like.

For example, a daemon may be started and is constantly looking at the source code of the nodes 400/weights 201 loaded into memory to see if they have changed in relation to the baseline information. By comparing the current structure information/current weight information to the baseline structure information/baseline weight information, the AI security manager 124 can detect a real-time attack of the AI algorithm 121 by comparing hashes/pointers 402/weights 201 etc. In addition, other types of attacks may be identified, such as a slow start attack against the AI algorithm 121.

If the comparison determines that there is a not a difference between the baseline structure information/baseline weight information and the current structure information/current weight information in step 508 (the AI algorithm 121 has not been compromised), the process goes to step 514. Otherwise, if there is a difference, the AI security manager 124 identifies, in step 510, that the AI algorithm 121 has been compromised. The AI security manager 124 may take one or more actions in step 512. For example, the action may be to notify a security analyst, shut down the AI algorithm 121, block access to the AI algorithm 121, reload the AI algorithm 121, reload the AI algorithm 121 from a first block in blockchain and get weights associated with the AI algorithm 121 from a second block in the blockchain, and/or the like. The process then goes to step 514.

The AI security manager 124 determines, in step 514, if the process is complete. If the process is not complete in step 514, the process goes to step 502. Otherwise, the process ends in step 516.

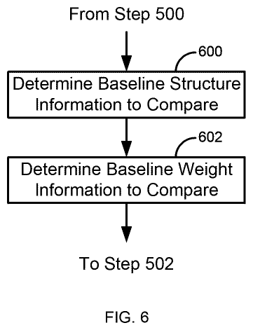

FIG. 6 is a flow diagram of a process for determining which baseline information to use when determining if an AI algorithm 121 has been compromised. The process of FIG. 6 goes between steps 500 and 502 of FIG. 5. After starting in step 500, the AI security manager 124 determines what baseline structure information to compare in step 600. What baseline information to compare in step 600 may be based on rules/administrative configurations. Some or all of the baseline structure information may be compared in step 600. For example, the hashes of the source code of the nodes 411 may be compared and/or the locations/lengths/pointers to the next nodes 412 may be compared.

The AI security manager 124 determines the baseline weight information to compare in step 602. The baseline weight information that is compared may be based on rules/administrative configurations. For example, the baseline weight information may comprise one or more of the hash of the weight file 123, the hashes of each weight 302, the hashes of the weights for each layer 303, the hashes of the flows of weights 304, a cumulative hash 305, and/or the like. The process then goes to step 502.

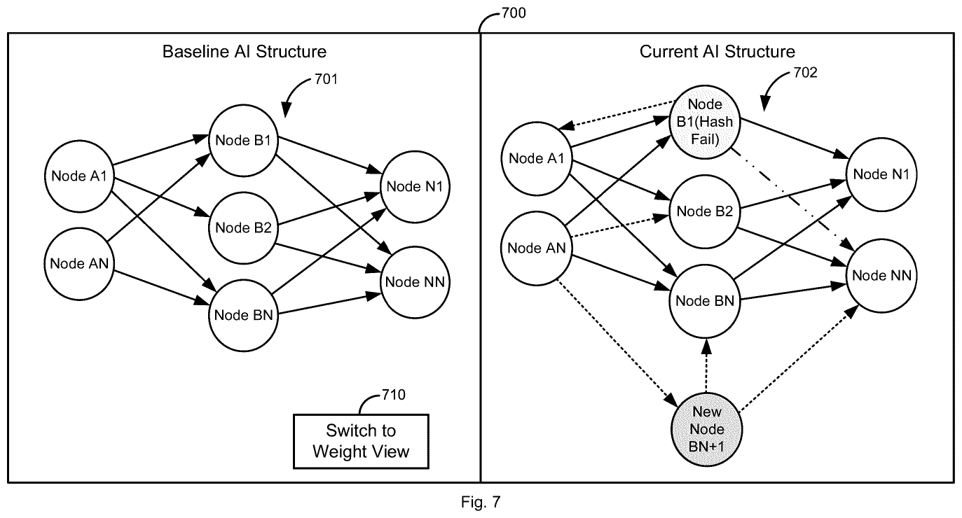

FIG. 7 is an exemplary display 700 (e.g., a graphical user interface) of a baseline AI structure 701 in comparison to a current AI structure 702. In FIG. 7, the neural network 122 is not a fully connected neural network 122. The baseline AI structure 701 is visual representation of the neural network 122 of the AI algorithm 121 when the AI algorithm 121 is trained. The current AI structure 702 is a visual representation of the current structure of the neural network 122 of the AI algorithm 121.

The current AI structure 702 shows the difference between the baseline AI structure 701 and the current AI structure 702. In the current AI structure 702, the pointers 402 that have a dashed line ( . . . . . . ) represent new pointers 402. In the current AI structure 702, the pointer 402 that has the dash-dot line (_. . . ._. . . ._. . . .) represents a pointer 402 that no longer exist. The grayed-out node 200 (new node BN+1) is a new node 200 that has been added to the neural network 122 in the current AI structure 702.

In the current AI structure 702, there are five new pointers 402: 1) a pointer 402 that goes from the node B1 to the node A1, 2) a pointer 402 that goes from the node AN to the Node B2, 3) a pointer 402 that goes from the node AN to the new node BN+1, 4) a pointer 402 that goes from the new node BN+1 to the node BN, and 5) a pointer 402 that goes from the new node BN+1 to the node NN. In the current AI structure 702, there is one removed pointer 402, from the node B1 to the node NN.

The node B1 (that has a light grey fill) indicates that the hash of the source code of the node 411B1 has failed. In other words, the source code of the node 400B1 has either been corrupted or has been compromised. If the user wanted more detail, the user could click on the node B1 to get more information about how the source code of the node 400B1 has changed. For example, after clicking on the node B1, a comparison of the baseline source code and the current source code may be displayed to the user. This way the user can learn whether the source code of the node 401B1 has been corrupted or changed in a way that may bias the AI algorithm.

Using the display 700, a user can compare the baseline AI structure 701 in relation to the current AI structure 702 to determine any changes to the current AI structure 702. In FIG. 7 there are various changes that include a new node BN+1 and additions/removal of different pointers 402. Although not shown, other types of changes may be shown, such as a removed node 200. The display 700 can help the user to identify the specific type of attack to the structure of the AI algorithm 121.

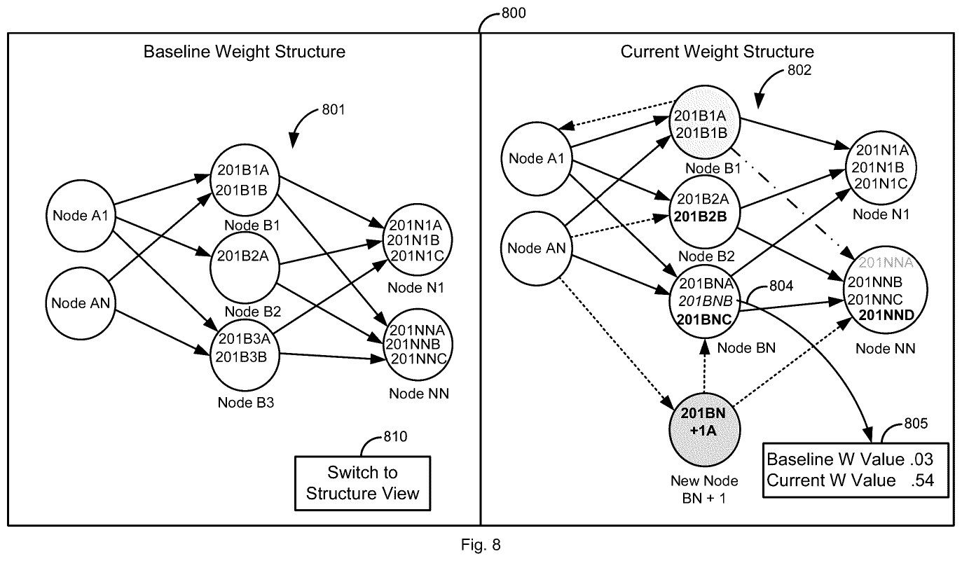

The user can click on the switch to weight view button 710 to now show the display 800 as described below. This allows the user to see not only changes to the structure of the AI algorithm 121, but also to view changes to the weights in the AI algorithm 121 as described in FIG. 8.

Although not shown, the baseline AI structure 701 and the current AI structure 702 may only show a portion of the baseline AI structure 701 and the current AI structure 702. For example, for a Large Language Model (LLM), the baseline AI structure 701 and the current AI structure 702 may include thousands to tens of thousands of layers 203. One way to deal with a large AI algorithm 121 could be to display what changes have been detected and allow the user to select specific change(s); this results in the user seeing a portion of the baseline AI structure 701 and a corresponding current AI structure 702 that are associated with the user selected specific change(s).

FIG. 8 is an exemplary display 800 of a baseline weight structure 801 in comparison to a current weight structure 802. The baseline weight structure 801 is an overlay of the baseline AI structure 701 of FIG. 7. Likewise, the current weight structure 802 is an overlay of the of the current AI structure 702. The difference between the display 700 and the display 800 is that the baseline weight structure 801 and the current weight structure 802 show the changes in the weights.

The weights with that are bolded (201B2B (in node B2), 201BNC (in node BN), 201BN+1A (new node BN+1), and 201NND (node NN)) are new weights. The weight 201NNA that is grayed out in the node BN is a weight that no longer exist.

The weight 201BNB (indicated by the italics) has been changed. The user can click on the weight 201BNB as shown in step 804 to display the weight change window 805. The weight change window 805 shows the baseline weight value (0.03) and the current weight value (0.54). This allows the user to see all the changes to the weights in the current weight structure 802.

The user can click on the switch to structure view button 810 to switch back to the display 700. The switch to structure view button 810 and the switch to weight view button 710 allows the user to toggle back and forth between the displays 700 and 800.

Although not shown, the baseline weight structure 801 and the current weight structure 802 may only show a portion of the baseline weight structure 801 and the current weight structure 802. For example, for a Large Language Model (LLM), the baseline weight structure 801 and the current weight structure 802 may include thousands to tens of thousands of layers 203. One way to deal with a large AI algorithm 121 could be to display what changes have been detected and allow the user to select specific change(s); this results in the user seeing a portion of the baseline weight structure 801 and a corresponding current weight structure 802 that are associated with the user selected specific change(s).

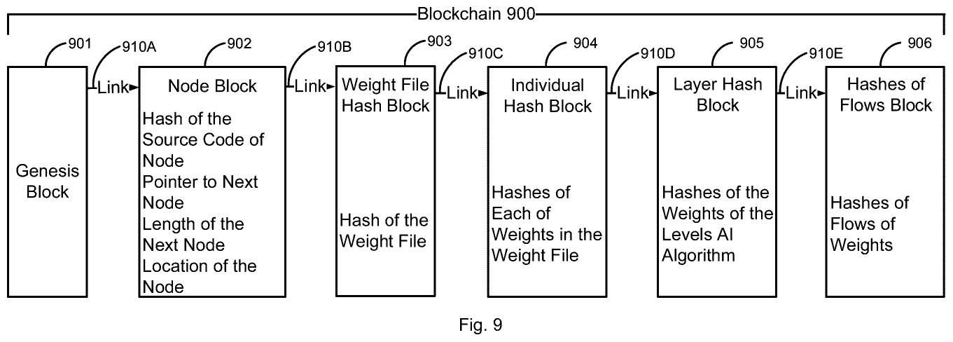

FIG. 9 is an exemplary embodiment of a blockchain 900 for storing baseline AI structure information 701 and baseline weight information 801. The blockchain 900 is typically a blockchain 900 that is stored as part of a distributed ledger where the blockchain 900 is replicated on a plurality of nodes that form the distributed ledger. However, in one embodiment, the blockchain 900 may be a stand-alone blockchain 900.

The blockchain 900 comprises a genesis block 901, a node block 902, a weight file hash block 903, an individual hash block 904, a level hash block 905, and a hashes of flows block 906. The blocks 901-906 are linked together by links 910A-910E. The links 910A-910E are forward links that link the blockchain 900 together as is traditionally done in blockchains 900. The blockchain may also comprise reverse links (not shown) that link the blockchain 900 together in a reverse (opposite) direction.

The genesis block 901 is a first block in the blockchain. Although not shown, the genesis block 901 may comprise information about what is in the blockchain 900.

The node block 902 is a block that stores baseline node information. In FIG. 9, the node block 902 comprises a hash of the source code of the node 400, a pointer to the next node 402 (could be pointers to many next nodes), a length of source code of the next node(s)/location of the next node(s) 412, and/or the like. The node block 902 may comprise three blocks, one for the hash(es) of the source code of the node(s) 400, one for the pointer(s) to the next node(s) 402, and one for the length of the source code of the next node(s)/location of the next node(s) 412. The node block 902 may comprise the information 400, 402, and 412 for all the nodes 200 or information 400, 402, and 412 for a portion of the nodes 200 or any combination of the above.

The weight file hash block 903 comprises the hash of the weight file 301. The weight file hash block 903 may comprise other information, such as a location of the weight file 123 and/or the like.

The individual hash block 904 comprises the hashes of each weight 302. In one embodiment, the individual hash block 904 may comprise a portion of the hashes of each weight 302.

The layer hash block 905 comprises the hashes of the weights for each layer 303. For example, the layer hash block 905 may have a hash for weights of the node layers 203B and 203N. In one embodiment, there may be separate level hash blocks 905 for each layer.

The hashes of flows block 906 comprises the hashes of flows of weights 304. In one embodiment, the hashes of flows block 906 may comprise a portion of the hashes of flows of weights 304.

While not shown, the blockchain 900 may comprise other blocks. For example, the blockchain 900 may have an AI algorithm block that has a copy of the AI algorithm 121, or a hash of the AI algorithm 121 and a link to the AI algorithm. In addition, the blockchain may have a weight block that has all the weights 201 that are in the weight file 123. If the AI algorithm becomes corrupted or is compromised, the AI algorithm 121 can be reloaded from the blockchain 900 along with the weights that are also stored in the weight block in the blockchain 900. Reloading from the blockchain 900 comprises (including in the claims) using a link stored in the blockchain 900 to reload the AI algorithm 121 from another location. If the AI algorithm 121 has been compromised, a compromise block can be added to the blockchain 900 that indicates that the AI algorithm was compromised. The compromise block may indicate the details of how the AI algorithm was compromised. For example, the compromise block may indicate that a group of weights were changed that causes a specific type of bias.

In addition, other blocks may be added to the blockchain 900. For example, the blockchain 900 may include a bock with the weight hash file 125, a block with the node structure file 126, a block that has a rule set for the AI algorithm 121, and/or the like.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
retrieve baseline structure information and/or baseline weight information associated with an AI algorithm;
retrieve current structure information and/or current weight information associated with the AI algorithm;
compare the baseline structure information and/or the baseline weight information to the current structure information and/or the current weight information;
in response to the baseline structure information and/or the baseline weight information being different from the current structure information and/or the current weight information, determining that the AI algorithm has been compromised; and
in response to the baseline structure information and/or the baseline weight information being the same as the current structure information and/or the current weight information, determining that the AI algorithm has not been compromised.

2. The system of claim 1, wherein comparing the baseline structure information and/or the baseline weight information to the current structure information and/or the current weight information comprises comparing the baseline structure information to the current structure information.

3. The system of claim 2, wherein the baseline structure information comprises one or more of: a hash of source code of a node in the AI algorithm, a pointer to a next node in the AI algorithm, a length of the source code of the node in the AI algorithm, and a location of the node in the AI algorithm.

4. The system of claim 3, wherein the baseline structure information comprises the hash of the source code of the node the node in the AI algorithm and wherein the hash of the node in the AI algorithm comprises individual hashes of the source code of a plurality of nodes in the AI algorithm.

5. The system of claim 3, wherein the baseline structure information comprises the pointer to the next node in the AI algorithm and wherein a pointer to the next node in the AI algorithm in the current structure information is changed in one of the following ways: the pointer to the next node in the AI algorithm is now pointing to a new node in the AI algorithm, the pointer to the next node in the AI algorithm is now pointing to a different existing node at a same layer in the in the AI algorithm, the pointer to the next node in the AI algorithm is now pointing to a node at a previous layer in the AI algorithm, and the pointer to the next node in the AI algorithm no longer exists.

6. The system of claim 3, wherein the hash of the source code of the node in the AI algorithm, the pointer to a next node in the AI algorithm, the length of the source code of the node of the AI algorithm, and the location of the node in the AI algorithm are stored in a blockchain.

7. The system of claim 2, wherein the current structure information comprises at least one of: a new node, a pointer from the new node to an existing node at a next layer, a pointer from the new node to a node at a same layer, a removed pointer, and a removed node.

8. The system of claim 1, wherein comparing the baseline structure information and/or the baseline weight information to the current structure information and/or the current weight information comprises comparing the baseline weight information to the current weight information.

9. The system of claim 1, wherein the baseline weight information comprises individual hashes of weights used by the AI algorithm.

10. The system of claim 1, wherein the baseline weight information comprises a hash of a layer of weights in the AI algorithm.

11. The system of claim 1, wherein the baseline weight information comprises a cumulative hash of layers of the AI algorithm.

12. The system of claim 1, wherein the baseline weight information comprises a hash of weights of a flow of the AI algorithm.

13. The system of claim 1, wherein a hash of a weight file, individual hashes of weights in the AI algorithm, a hash of a layer of weights in the AI algorithm, and a hash of weights of a flow of the AI algorithm are stored in separate blocks in a blockchain.

14. The system of claim 1, wherein the current structure information and/or the current weight information are captured in real-time while the AI algorithm is running.

15. The system of claim 1, wherein at least a portion of the baseline structure information and/or the baseline weight information, and at least a portion of the current structure information and/or at least a portion of the current weight information are displayed in a graphical user interface at a same time.

16. The system of claim 15, wherein the graphical user interface displays the at least a portion of the baseline structure information and the at least a portion of the current structure information and wherein the at least a portion of the current structure information shows at least one of: a new node, a removed node, a failed hash of source code of a node of the AI algorithm, a new pointer, and a removed pointer.

17. The system of claim 15, wherein the graphical user interface displays the at least a portion of the baseline weight information and the at least a portion of the current weight information and wherein the at least a portion of the current weight information shows at least one of: a changed weight, a new weight, and a removed weight.

18. The method of claim 1, wherein microprocessor readable and executable instructions further cause the microprocessor to:
in response to determining that the AI algorithm has been compromised reload the AI algorithm from a first block in blockchain, wherein reloading the AI algorithm from the first block in the blockchain comprises getting weights associated with the AI algorithm from a second block in the blockchain.

19. The method of claim 18, wherein microprocessor readable and executable instructions further cause the microprocessor to:
add compromise block to the blockchain, wherein the compromise block includes information about how the AI algorithm was compromised.

20. A method comprising:
retrieving, by a microprocessor, baseline structure information and/or baseline weight information associated with an AI algorithm;
retrieving, by the microprocessor, current structure information and/or current weight information associated with the AI algorithm;
comparing, by the microprocessor, the baseline structure information and/or the baseline weight information to the current structure information and/or the current weight information;
in response to the baseline structure information and/or the baseline weight information being different from the current structure information and/or the current weight information, determining, by the microprocessor, that the AI algorithm has been compromised; and
in response to the baseline structure information and/or the baseline weight information being the same as the current structure information and/or the current weight information, determining, by the microprocessor that the AI algorithm has not been compromised.

21. The method of claim 20, wherein comparing the baseline structure information and/or the baseline weight information to the current structure information and/or the current weight information comprises comparing the baseline structure information to the current structure information.

22. The method of claim 21, wherein the baseline structure information comprises one or more of: a hash of source code of a node in the AI algorithm, a pointer to a next node in the AI algorithm, a length of the source code of the node in the AI algorithm, and a location of the node in the AI algorithm.

23. The method of claim 21, wherein the current structure information comprises at least one of: a new node, a pointer from the new node to an existing node at a next layer, a pointer from the new node to a node at a same layer, a removed pointer, and a removed node.

24. The method of claim 20, wherein the baseline weight information comprises individual hashes of weights used by the AI algorithm.

25. The method of claim 20, wherein the baseline weight information comprises a hash of a layer of weights in the AI algorithm.

26. The method of claim 20, wherein the baseline weight information comprises a hash of weights of a flow of the AI algorithm.

27. The method of claim 20, wherein the current structure information and/or the current weight information are captured in real-time while the AI algorithm is running.

28. The method of claim 20, wherein at least a portion of the baseline structure information and/or the baseline weight information, and at least a portion of the current structure information and/or at least a portion of the current weight information are displayed in a graphical user interface at a same time.

29. The method of claim 28, wherein the graphical user interface displays the at least a portion of the baseline structure information and the at least a portion of the current structure information and wherein the at least a portion of the current structure information shows at least one of: a new node, a removed node, a failed hash of source code of a node of the AI algorithm, a new pointer, and a removed pointer.

30. The system of claim 28, wherein the graphical user interface displays the at least a portion of the baseline weight information and the at least a portion of the current weight information and wherein the at least a portion of the current weight information shows at least one of: a changed weight, a new weight, and a removed weight.

31. A non-transient computer readable medium having stored thereon instructions that cause a processor to execute a method, the method comprising instructions to:
retrieve baseline structure information and/or baseline weight information associated with an AI algorithm;
retrieve current structure information and/or current weight information associated with the AI algorithm;
compare the baseline structure information and/or the baseline weight information to the current structure information and/or the current weight information;
in response to the baseline structure information and/or the baseline weight information being different from the current structure information and/or the current weight information, determining that the AI algorithm has been compromised; and
in response to the baseline structure information and/or the baseline weight information being the same as the current structure information and/or the current weight information, determining that the AI algorithm has not been compromised.
